(19) United States
(12) Patent Application Publication
(10) Pub. No.: US 2021/0080884 A1
(43) Pub. Date: Mar. 18, 2021

(54) START CONTROL DEVICE AND IMAGE FORMING APPARATUS

(71) Applicant: TOSHIBA TEC KABUSHIKI KAISHA, Tokyo (JP)

(72) Inventor: Atsuhiko Eguchi, Sunto Shizuoka (JP)

(21) Appl. No.: 17/109,377

(22) Filed: Dec. 2, 2020

Related U.S. Application Data
(63) Continuation of application No. 16/572,775, filed on Sep. 17, 2019.

(51) Int. Cl. G03G 15/20

(52) U.S. Cl. CPC G03G 15/2039

(57) ABSTRACT

According to one embodiment, a start control device includes a memory, an interface, and a processor. The memory stores management information which includes a system preparation time required to complete preparation of a system from starting the system and a fusing preparation time required to complete preparation of a fuser from starting heating of the fuser. A start command is received via the interface. The processor controls a timing of starting the system and a timing of starting the heating of the fuser to equalize a first timing at which the preparation of the system is completed and a second timing at which the preparation of the fuser is completed, based on the start command and the management information.

### CROSS-REFERENCE TO RELATED APPLICATION

This application is a Continuation of application Ser. No. 16/572,775 filed on Sep. 17, 2019, the entire contents of which are incorporated herein by reference.

### FIELD

Embodiments described herein relate generally to a start control device, an image forming apparatus, and methods related thereto.

### BACKGROUND

An image forming apparatus, such as a copying machine or a multi-functional peripheral (MFP), which uses an electrophotographic process is known. A total preparation time of an image forming apparatus depends on both a system preparation time required to complete preparation of the system from starting the system and a fusing preparation time required until a temperature of a fuser falls within a target temperature range.

When the fusing preparation time is shorter than the system preparation time, it may not be efficient to start the system and start heating of the fuser substantially simultaneously, in response to a system command. That is, because the preparation of the fuser is completed prior to the preparation of the system, there is a waiting time until the system is prepared and thus power for maintaining the temperature of the fuser is wasted during the waiting time. In contrast, when the system preparation time is shorter than the fusing preparation time, a total preparation time may become longer than necessary unless the heating of the fuser is started quickly.

### DESCRIPTION OF THE DRAWINGS

FIG. 1 is an external view illustrating an example of an overall configuration of an image forming apparatus according to an embodiment;

FIG. 2 is a schematic block diagram illustrating an example of an overall configuration of the image forming apparatus;

FIG. 3 is a schematic block diagram illustrating an example of components, such as a system processor;

FIG. 4 is a schematic view of an example of a configuration of a fuser;

FIG. 5 is a schematic view of a control mechanism of the fuser;

FIG. 6A is a diagram schematically illustrating power supply control (continuous power supply control) performed on the fuser;

FIG. 6B is a diagram schematically illustrating power supply control (partial power supply control) performed on a fuser of an image forming apparatus according to another embodiment;

FIG. 7 is a diagram illustrating the relationship between an environmental temperature and a fusing preparation time;

FIG. 8 is a timing chart illustrating an example of start control performed by the system processor and the like;

FIG. 9 is a flowchart illustrating an example of start control performed by the system processor and the like;

FIG. 10 is a diagram illustrating an example of applying partial power supply control by the system processor and the like; and

FIG. 11 is a diagram illustrating an example of selectively performing continuous power supply control and partial power supply control by the system processor and the like.

### DETAILED DESCRIPTION

In general, according to one embodiment, a start control device includes a memory, an interface, and a processor. The memory stores management information which includes a system preparation time required to complete preparation of the system from starting the system and a fusing preparation time required to complete preparation of a fuser from starting heating of the fuser. A start command is received via the interface. The processor controls a timing of starting the system and a timing of starting heating of the fuser to equalize a first timing at which the preparation of the system is completed and a second timing at which the preparation of the fuser is completed, based on the start command and the management information. According to another embodiment, a start control method for an image forming apparatus involves receiving a start command; and controlling a timing of starting non-fuser components of the image forming apparatus and a timing of starting the heating of the fuser to equalize a first timing at which the preparation of the non-fuser components is completed and a second timing at which the preparation of the fuser is completed, based on the start command and management information, the management information comprising a non-fuser components preparation time required to complete preparation of non-fuser components of the image forming apparatus from starting the non-fuser components of the image forming apparatus and a fusing preparation time required to complete preparation of a fuser from starting heating of the fuser.

Hereinafter, an example of an image forming apparatus with a start control device according to an embodiment will be described with reference to the accompanying drawings. In each of the drawings, the same reference numeral is assigned the same element.

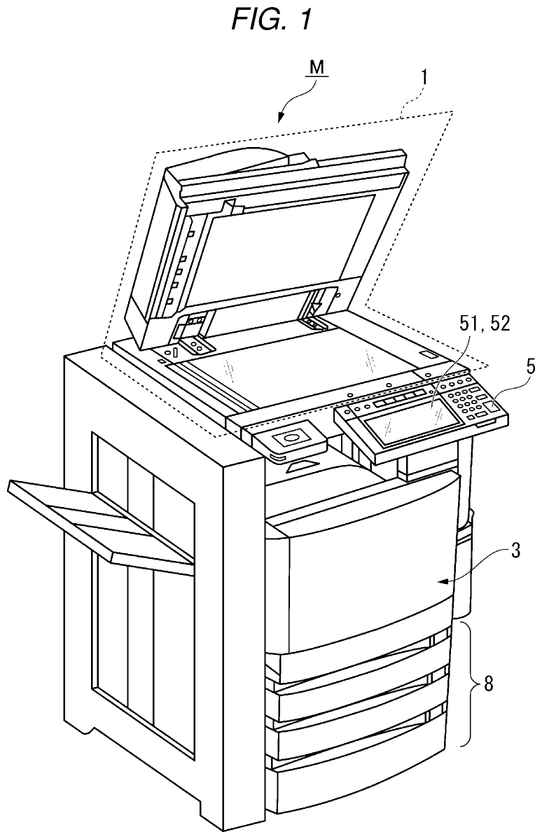

FIG. 1 is an external view illustrating an overall configuration of an image forming apparatus M according to an embodiment. The image forming apparatus M is, for example, a multi-functional peripheral (MFP). The image forming apparatus M includes an image reader 1, an image output unit (printer unit) 3, a control panel unit 5, and a sheet accommodating unit 8. The image output unit 3 of the image forming apparatus M includes a fuser for fusing a toner image. The control panel unit 5 includes a display 51 and an input interface 52.

The image forming apparatus M forms an image on a sheet by using a developer such as toner. The sheet is, for example, paper or label paper. The type of the sheet is not limited as long as an image can be formed on a surface thereof by the image forming apparatus M.

A user's manipulation is received via the control panel unit 5. The control panel unit 5 outputs a signal corresponding to an operation performed by the user to a system processor of the image forming apparatus M.

The image output unit 3 forms an image on a sheet, based on image information generated by the image reader 1 or image information received via a communication path. The image output unit 3 forms an image by, for example, a process which will be described below. An image forming apparatus of the image output unit 3 forms an electrostatic latent image on a photosensitive drum, based on the image information. The image forming apparatus of the image output unit 3 forms a visible image by adhering a developer onto the electrostatic latent image. A concrete example of the developer is a toner. A paper feeding device of the image output unit 3 feeds a sheet accommodated in the sheet accommodating unit 8 or a sheet supplied manually by hand, and a transfer device of the image output unit 3 transfers the visible image onto the sheet. A fuser of the image output unit 3 fuses the visible image on the sheet by heating and pressing the sheet. The sheet accommodating unit 8 accommodates a sheet to be used to form an image by the image output unit 3.

The image reader 1 reads image information to be read using light and darkness of light. The image reader 1 records the read image information. The recorded image information maybe transmitted to another information processing apparatus via a network. An image of the recorded image information may be formed on the sheet by the image output unit 3.

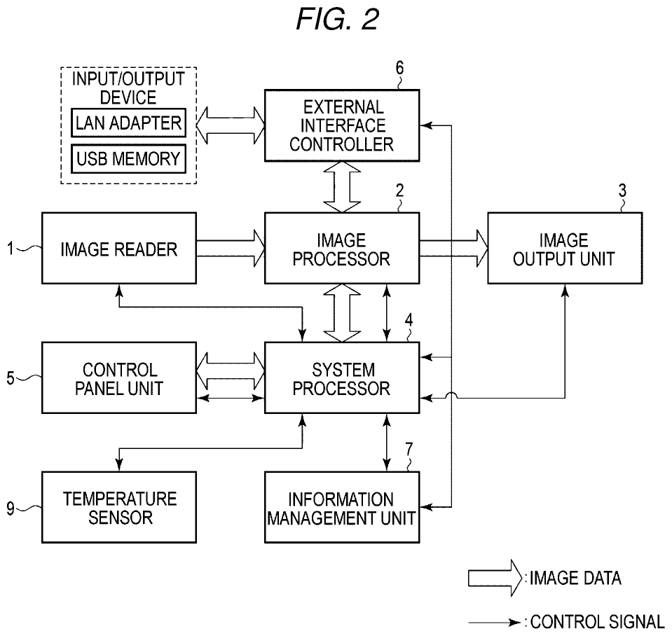

FIG. 2 is a block diagram illustrating an example of an overall configuration of an image forming apparatus M according to an embodiment. As illustrated in FIG. 2, the image forming apparatus M includes an image reader 1, an image processor 2, an image output unit 3, a system processor 4, a control panel unit 5, an external interface controller 6, an information management unit 7, and a temperature sensor 9.

The image reader 1 reads an image of an original document placed on an original document table and outputs image data or reads an image of a document, each piece of which is transferred to the document table from an automatic document feeder called auto document feeder (ADF) and outputs image data, in response to execution of a scanner mode or a copy mode.

The image processor 2 corrects gradation of the image data output from the image reader 1 or the external interface controller 6, and enhances the image quality of the image data. The image output unit 3 outputs the image, based on the image data processed by the image processor 2. The system processor 4 controls all the components of the image forming apparatus, based on a program stored in advance and information of the components. For example, the system processor 4 is configured as at least a part of a start control device that performs start control which will be described in detail later.

The control panel unit 5 guides and displays information regarding an operation of the image forming apparatus M to the user. Furthermore, the control panel unit 5 receives an operation input from the user and sets various types of information based on the operation input. For example, the control panel unit 5 sets setting information, based on the operation input from the user.

Image data is input to or output from the external interface controller 6 when the external interface controller 6 is connected to an input/output device (a non-transitory computer-readable storage medium) such as a local area network (LAN) adapter or a Universal Serial Bus (USB) memory. In addition, a program or the like may be input to the external interface controller 6 via the input/output device. The information management unit 7 manages (stores) the setting information which is set by the control panel unit 5. The temperature sensor 9 senses a temperature of an environment in which the image forming apparatus M is installed.

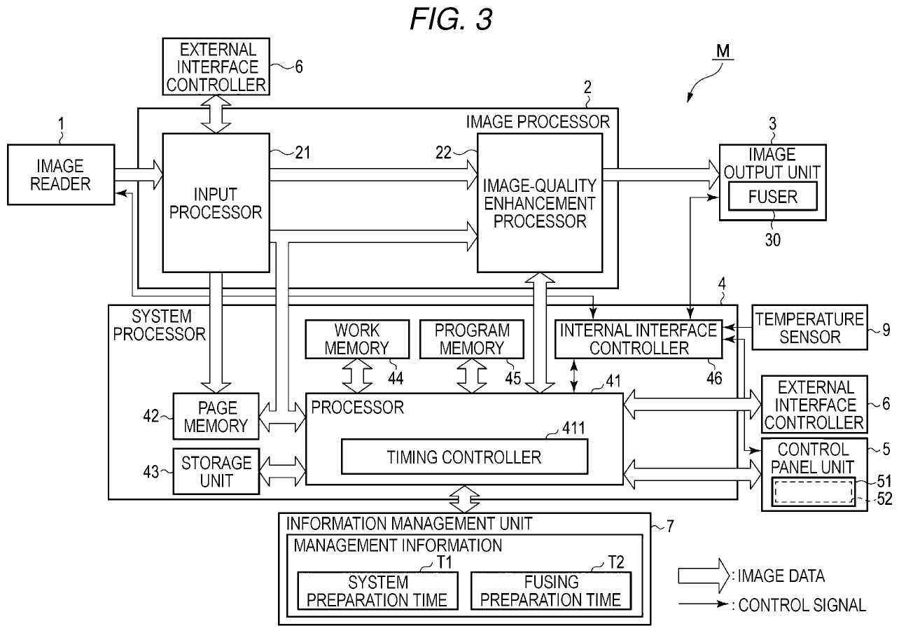

FIG. 3 is a schematic block diagram illustrating an example of components, such as a system processor 4, of an image forming apparatus M according to an embodiment. As illustrated in FIG. 3, the system processor 4 includes a processor 41, a page memory 42, a storage unit 43, a work memory 44, a program memory 45, an internal interface controller 46, and the like. An example of the processor 41 is a central processing unit (CPU), a micro-processing unit (MPU), a digital signal processor (DSP), or the like.

The processor 41 receives various signals from the image reader 1, the image output unit 3 (a fuser 30), the control panel unit 5, and the temperature sensor 9 via the internal interface controller 46, and transmits the various signals. The processor 41 is operated on the basis of a program stored in the program memory 45 or the like, and performs start control, for example, according to a start command, as a trigger, which is input from a user via the control panel unit 5. For example, a timing controller 411 performs start control according to the start command. The work memory 44 temporarily stores a program stored in the program memory 45 or the like, and temporarily stores data processed by the program.

A procedure such as processing or controlling described above in the present embodiment is executable by software. Thus, the procedure such as processing or controlling may be easily implemented by installing a program for execution of the procedure such as processing or controlling in an image forming apparatus via a non-transitory computer-readable storage medium storing the program and then executing the program.

For example, the installation of the program may be completed by reading the program from the non-transitory computer-readable storage medium via the external interface controller 6 and storing the read program in the storage unit 43 or the like. Thus, the processing or controlling may be easily implemented by the processor 41 of the image forming apparatus M according to the installed program.

The page memory 42 temporarily stores image data read by the image reader 1 through the image processor 2. Furthermore, the page memory 42 temporarily stores the image data output from the external interface controller 6 through the image processor 2. The image data stored in the page memory 42 is converted into YMCK image data by a process of a raster image processor (RIP) in a print mode. The image processor 2 enhances the image quality of the YMCK image data, and the image output unit 3 forms an image on the basis of the YMCK image data, the image quality of which is enhanced.

The storage unit 43 is an information storage device such as a hard disk drive (HDD) or a solid state drive (SSD), and stores the image data transmitted from the page memory 42. In addition, the storage unit 43 may store part or all of a program for operating the processor 41.

The control panel unit 5 includes a display 51 and an input interface 52. The display 51 is an image display device such as a liquid crystal display (LCD) or an organic electroluminescence (EL) display. The display 51 displays various types of information regarding the image forming apparatus M. The input interface 52 is an input device, such as a touch panel, which is provided to correspond to the display 51. The input interface 52 senses a touch input from a user, and outputs the touch input by mapping it to location information of X and Y coordinates on the display 51. The control panel unit 5 may further include an input device such as a hard key.

Furthermore, the image processor 2 includes an input processor 21 and an image-quality enhancement processor 22 as illustrated in FIG. 3. The input processor 21 includes a look-up table (LUT) processor for correction of tone reproduction, and corrects tone reproduction of image data which is input from the image reader 1 or the external interface controller 6. The image-quality enhancement processor 22 conducts image quality enhancement on the image data, based on filtering, scaling, density adjustment, gradation control, etc.

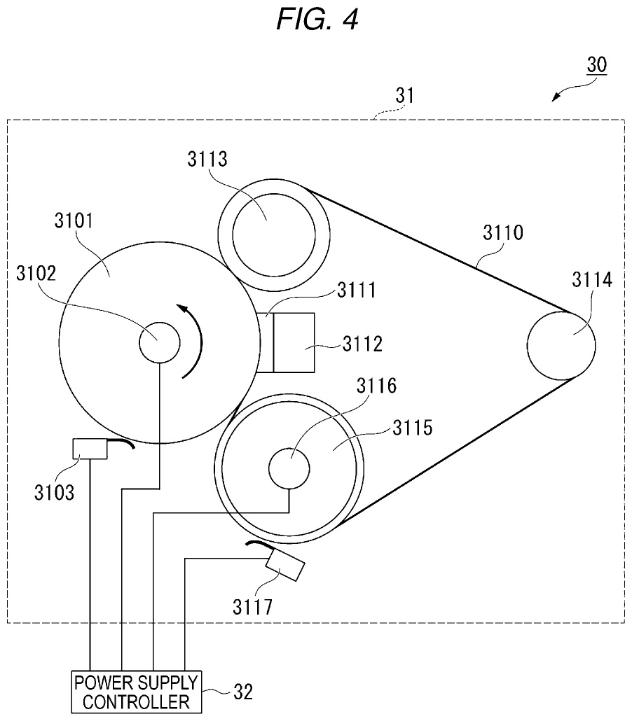

FIG. 4 is a schematic view of an example of a configuration of a fuser 30 of an image forming apparatus according to an embodiment. The fuser 30 includes a fusing unit 31 and a power supply controller 32. The fusing unit 31 fuses a visible image on a sheet transferred thereto. The power supply controller 32 controls power to be supplied to a lamp of the fusing unit 31 according to a control signal from the processor 41 of the system processor 4. The power supply controller 32 may be a component (a component of a part for controlling the start of the fuser 30) of a part of a start control device.

The fusing unit 31 will be described in detail below. The fusing unit 31 is a part of the fuser 30 of the image output unit 3. The fusing unit 31 includes a heat roller 3101, an HR lamp 3102, an HR thermistor 3103, a pressure belt 3110, a pressure pad 3111, a pad holder 3112, a pressure roller 3113, a tension roller 3114, a belt heat roller 3115, a pressure belt lamp 3116, and a pressure thermistor 3117.

The heat roller 3101 is a fuser member formed in a cylindrical shape. The HR lamp 3102 is installed in the heat roller 3101. The HR lamp 3102 heats the heat roller 3101 by generating heat. The HR lamp 3102 is configured using, for example, a halogen lamp. The HR thermistor 3103 measures a surface temperature of the heat roller 3101.

The pressure belt 3110 is held by the pressure roller 3113, the tension roller 3114 and the belt heat roller 3115. The pressure belt 3110 is brought into pressure contact with the heat roller 3101 by the pressure pad 3111 and the pressure roller 3113. A fusing nip portion is formed between the pressure belt 3110 and the heat roller 3101 due to the pressure contact.

The pressure pad 3111 is held in pressure contact with the heat roller 3101 via the pressure belt 3110. The pad holder 3112 holds the pressure pad 3111 in pressure contact with the heat roller 3101.

The pressure roller 3113 is disposed downstream in a sheet conveyance direction. The pressure roller 3113 brings the pressure belt 3110 into pressure contact with the heat roller 3101. An exit of the fusing nip portion is formed by the pressure roller 3113. The tension roller 3114 is disposed at a position apart from the pressure roller 3113 and the belt heat roller 3115 to apply tension to the pressure belt 3110. The belt heat roller 3115 is disposed upstream in the sheet conveyance direction. The belt heat roller 3115 is formed in a hollow cylindrical shape. The pressure belt lamp 3116 is provided inside the belt heat roller 3115. The pressure belt lamp 3116 heats the belt heat roller 3115 by generating heat. The pressure belt lamp 3116 is configured using, for example, a halogen lamp. The pressure thermistor 3117 measures surface temperature of the pressure belt 3110 near the belt heat roller 3115.

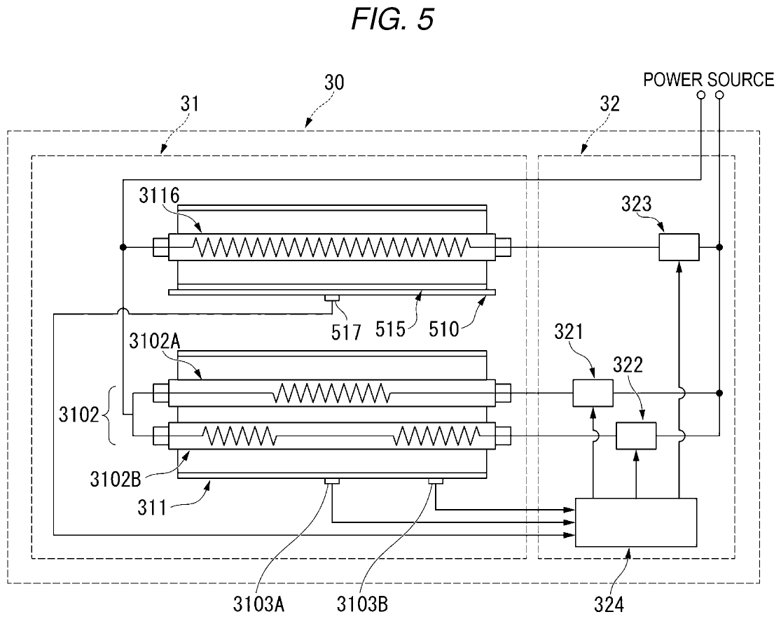

FIG. 5 is a schematic view of a control mechanism of a fuser 30 of an image forming apparatus according to an embodiment. The HR lamp 3102 includes a plurality of lamps. The HR lamp 3102 includes a first HR lamp 3102A and a second HR lamp 3102B. The first HR lamp 3102A includes a heat generating portion (heat source) near a center of the heat roller 3101 in a longitudinal direction. The first HR lamp 3102A heats the vicinity of the center of the heat roller 3101 in the longitudinal direction by generating heat. The second HR lamp 3102B includes heat generating portions (heat sources) near both ends of the heat roller 3101 in the longitudinal direction. The second HR lamp 3102B heats the vicinity of the both ends of the heat roller 3101 in the longitudinal direction by generating heat. The pressure belt lamp 3116 includes a heat generating portion (heat source) on the entire belt heat roller 3115 in the longitudinal direction. The pressure belt lamp 3116 heats the entire belt heat roller 3115 in the longitudinal direction by generating heat.

The first HR lamp 3102A includes the heat generating portion (heat source) having a width substantially the same as, for example, a vertical size of A4 paper. The second HR lamp 3102B includes the heat generating portions (heat sources) at positions corresponding to, for example, near both ends of a horizontal size of A4 paper. The first HR lamp 3102A, the second HR lamp 3102B, and the pressure belt lamp 3116 may be configured using lamps of the same output (for example, 300 W). The first HR lamp 3102A, the second HR lamp 3102B and the pressure belt lamp 3116 may be configured using lamps of different outputs.

The HR thermistor 3103 includes a plurality of thermistors. In the present embodiment, the HR thermistor 3103 includes a first HR thermistor 3103A and a second HR thermistor 3103B. The first HR thermistor 3103A is disposed near the center of the heat roller 3101 in the longitudinal direction. The first HR thermistor 3103A measures surface temperature near the center of the heat roller 3101 in the longitudinal direction. The second HR thermistor 3103B is disposed near one end of the heat roller 3101 in the longitudinal direction. The second HR thermistor 3103B measures surface temperature near the one end of the heat roller 3101 in the longitudinal direction. The pressure thermistor 3117 is disposed near the belt heat roller 3115. For example, the pressure thermistor 3117 is disposed near the center of the belt heat roller 3115 in the longitudinal direction. In this case, the pressure thermistor 3117 measures the surface temperature of the pressure belt 3110 near the center of the belt heat roller 3115 in the longitudinal direction.

The power supply controller 32 includes a first switching element 321, a second switching element 322, a third switching element 323, and a controller 324. For example, the first switching element 321, the second switching element 322, and the third switching element 323 are configured using bidirectional thyristors.

The first switching element 321 is provided between a power source and the first HR lamp 3102A. The first switching element 321 is in an ‘on’ state or an ‘off’ state. A state of the first switching element 321 is controlled by the controller 324. When the first switching element 321 is in the ‘on’ state, alternating current (AC) power is supplied to the first HR lamp 3102A from the power source. The second switching element 322 is provided between the power source and the second HR lamp 3102B. The second switching element 322 is in the ‘on’ state or the ‘off’ state. A state of the second switching element 322 is controlled by the controller 324. When the second switching element 322 is in the ‘on’ state, AC power is supplied to the second HR lamp 3102B from the power source. The third switching element 323 is provided between the power source and the pressure belt lamp 3116. The third switching element 323 is in the ‘on’ state or the ‘off’ state. A state of the third switching element 323 is controlled by the controller 324. When the third switching element 323 is in the ‘on’ state, AC power is supplied to the pressure belt lamp 3116 from the power source.

The controller 324 obtains signals output from the first HR thermistor 3103A, the second HR thermistor 3103B, and the pressure thermistor 3117. The controller 324 obtains a result of measuring temperature (hereinafter, referred to as “measured temperature”), based on the obtained signals. The controller 324 controls the first switching element 321, the second switching element 322, and the third switching element 323, based on the obtained measured temperature. For example, the controller 324 may obtain, as the measured temperature, an average of measurement values obtained by the first HR thermistor 3103A and the second HR thermistor 3103B.

The control unit 324 performs first heating control or second heating control or selectively performs first heating control and second heating control by controlling each switching element to maintain the measured temperature to be within a target temperature range. For example, the controller 324 turns on each of these lamps to perform first heating control (continuous power supply control). Furthermore, the controller 324 performs second heating control (partial power supply control) by partially supplying power to each lamp. When partial power supply control is performed, the controller 324 controls switching between turning on and off each switching element at certain time intervals (short time intervals). By performing such control, the amount of AC power to be supplied to each lamp per hour may be adjusted. The on and off control is performed at zero crossing of AC voltage. Through such control, partial power supply control may be performed safely with less energy loss. Partial power supply control may be performed only on the first HR thermistor 3103A and the second HR thermistor 3103B.

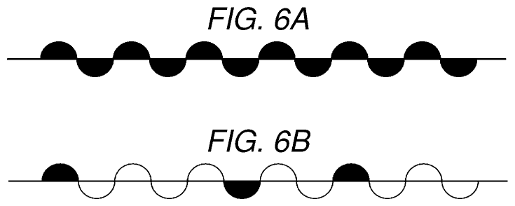

FIGS. 6A and 6B are diagrams schematically illustrating power supply control performed on a fuser of an image forming apparatus according to an embodiment. FIG. 6A is a diagram illustrating a change of a supply voltage over time when 100% of AC power is supplied through first heating control (continuous power supply control). FIG. 6B is a diagram illustrating a change of a supply voltage over time when 25% of the AC power is supplied through second heating control (partial power supply control). Each of waveforms illustrated in FIGS. 6A and 6B represents a change of a voltage, which is supplied from the power source to the fuser 30, over time. Black-colored inner parts of each of the waveforms represent a voltage supplied to a lamp. White-colored inner parts of the waveform represent a voltage that was not supplied to the lamp through partial power supply control.

In the continuous power supply control illustrated in FIG. 6A performed to supply 100% of the AC power, all voltages supplied to the fuser 30 from the power source are supplied to the lamp. On the other hand, in partial power supply control illustrated in FIG. 6B performed to supply 25% of the AC power (in a state in which a partial supply rate is 75%), the supply of the AC power is stopped for a time corresponding to 75% of a certain time.

Next, start control performed by the system processor 4 and the like of the image forming apparatus M according to an embodiment will be described. Start control is performed by the processor 41 of the system processor 4, based on a start control program or the like stored in the program memory 45 or the like. For example, the timing controller 411 outputs a control signal according to an instruction from the processor 41.

The information management unit 7 is a memory storing management information, and the management information includes a system preparation time T1 and a fusing preparation time T2. The system preparation time T1 is a time required to complete preparation of the system from starting the system. The system preparation time T1 refers to a time from starting power supply, executing the program stored in the program memory 45, performing initialization operations of the respective units by setting initial parameters to the image processor 2, the image output unit 3, etc., and completing these operations. The fusing preparation time T2 refers to a time required to complete preparation of the fuser 30 from starting heating of the fuser 30. The fusing preparation time T2 refers to a time required until measured surface temperatures of the heat roller 3101 and the belt heat roller 3115 reach a target temperature range (a lowest limit of the target temperature range), when continuous power supply control or partial power supply control is performed on the fuser 30, or continuous power supply control and partial power supply control are selectively performed on the fuser 30.

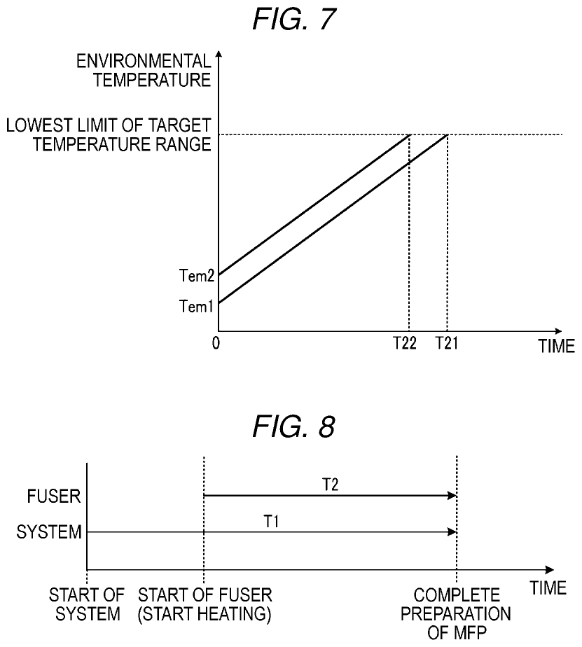

Here, the relationship between an environmental temperature and the fusing preparation time T2 will be described. FIG. 7 is a diagram illustrating the relationship between an environmental temperature and a fusing preparation time T2. As illustrated in FIG. 7, a fusing preparation time is T21 at an environmental temperature Tem1, and a fusing preparation time is T22 (T22<T21) at an environmental temperature Tem2 (Tem1<Tem2). That is, as the environmental temperature is high, the fusing preparation time T2 decreases. Thus, in the management information, the fusing preparation time T2 is stored to correspond to an assumed environmental temperature. As an example, in the management information, fusing preparation times T2 may be stored to correspond to environmental temperatures.

FIG. 8 is a timing chart illustrating an example of start control performed by the system processor 4 and the like of the image forming apparatus M according to an embodiment. Although FIG. 8 illustrates a case in which a system preparation time T1 is longer than a fusing preparation time T2, there may be cases in which the fusing preparation time T2 is longer than the system preparation time T1.

When receiving a start command, the processor 41 may obtains the system preparation time T1 from the management information, and obtains the fusing preparation time T2 according to an environmental temperature sensed by the temperature sensor 9. The processor 41 compares the system preparation time T1 with the fusing preparation time T2, and calculates a difference time (T1−T2) therebetween and starts the system, when it is determined that the system preparation time T1 is loner than or equal to the fusing preparation time T2. Furthermore, the processor 41 starts heating the fuser 30 after the calculated difference time elapses. Accordingly, a first timing at which the preparation of the system is completed and a second timing at which the preparation of the fuser 30 is completed may be equalized.

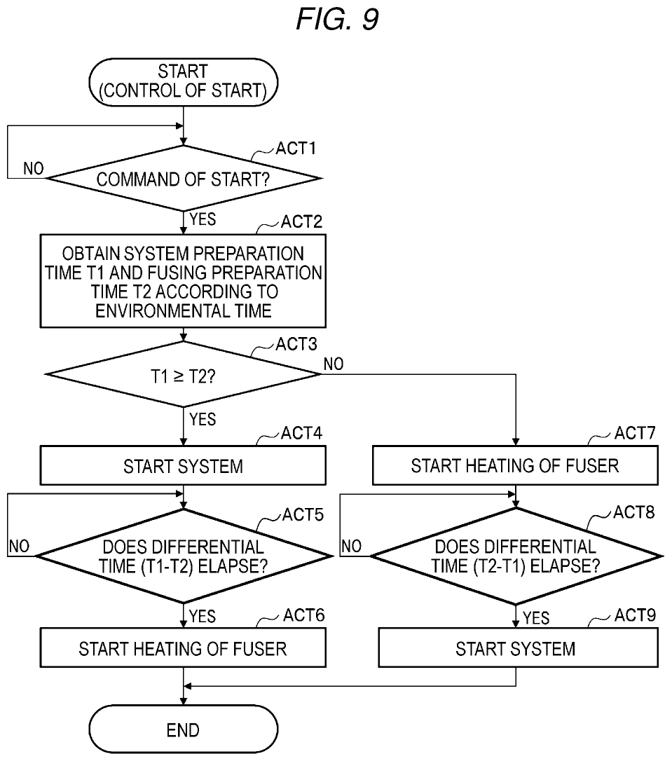

FIG. 9 is a flowchart illustrating an example of start control performed by the system processor 4 and the like of the image forming apparatus M according to an embodiment. Here, it is assumed that the image forming apparatus M is in an operation stop state. A minimum amount of standby power is supplied to the image forming apparatus M that is in the operation stop state. When a start command is input to the control panel unit 5 of the image forming apparatus M, the control panel unit 5 outputs the start command and the internal interface controller 46 notifies the processor 41 of the start command. When receiving the start command via the internal interface controller 46 (ACT 1), the processor 41 starts start control. The processor 41 obtains a system preparation time T1 from the information management unit 7, obtains an environmental temperature sensed by the temperature sensor 9 (hereinafter, referred to as a ‘sensed environmental temperature’), and further obtains a fusing preparation time T2 corresponding to the sensed environmental temperature (ACT 2).

When the processor 41 compares the system preparation time T1 with the fusing preparation time T2 and determines that the system preparation time T1 is longer than or equal to the fusing preparation time T2 (ACT 3, YES), a difference time (T1−T2) between the system preparation time T1 and the fusing preparation time T2 is calculated and the system is started (ACT 4). The processor 41 instructs to start supplying power, executes a program stored in the program memory 45, sets initial parameters of the image processor 2 and the image output unit 3, and instructs to perform initialization operations of the image processor 2 and the image output unit 3.

Furthermore, the processor 41 monitors whether the difference time elapses after the starting of the system, and instructs to start the fuser 30 when the difference time elapses (ACT 5, YES). That is, the processor 41 instructs the fuser 30 to start heating (ACT 6). The power supply controller 32 of the fuser 30 instructs to start power supply according to the instruction to start the fuser 30(start heating). The control unit 324 performs continuous power supply control or partial power supply control or selectively performs continuous power supply control and partial power supply control, based on the instruction to start power supply, so that measured surface temperatures of the heat roller 3101 and the belt heat roller 3115 reach a target temperature range (a lowest limit of the target temperature range).

Alternatively, when the processor 41 compares the system preparation time T1 with the fusing preparation time T2 and determines that the system preparation time T1 is shorter than the fusing preparation time T2 (ACT 3, NO), the difference time (T2−T1) between the system preparation time T1 and the fusing preparation time T2 is calculated and the starting of the fuser 30 is instructed. That is, the processor 41 instructs the fuser 30 to start heating (ACT 7). The power supply controller 32 of the fuser 30 instructs to start power supply, based on the instruction to start the fuser 30 (start heating). The controller 324 performs continuous power supply control or partial power supply control or selectively performs continuous power supply control and partial power supply control, based on the instruction to start power supply.

In addition, the processor 41 monitors whether the difference time elapses after the starting, and starts the system (ACT 9) when it is determined that the difference time elapses (ACT 8, YES). The processor 41 instructs to start supplying power, and executes a program stored in the program memory 45 to set initial parameters of the image processing unit 2 and the image output unit 3 and instruct to perform initialization operations of the image processor 2 and the image output unit 3.

Thereby, a first timing at which the preparation of the system is completed and a second timing at which the preparation of the fuser 30 is completed may be equalized. For example, because the first and second timings are equalized substantially, the preparation of the image forming apparatus M may be completed at the timings occurring simultaneously.

When the start control of the present embodiment is not applied and thus the preparation of the fuser 30 is completed before the preparation of the system is completed, more power is wasted to maintain the fuser 30 to be within a target temperature range until the preparation of the system is completed. In other words, a power saving effect can be obtained by applying the start control of the present embodiment.

Furthermore, when the start control of the present embodiment is not applied and thus a timing of starting the system and a timing of starting the fuser 30 are displaced by a fixed time difference, the timing at which the preparation of the fuser 30 is completed and the timing at which the preparation of the system is completed may not coincide, thereby causing a user to wait. In other words, when the start control of the present embodiment is applied, a power saving effect can be obtained without causing the user to wait.

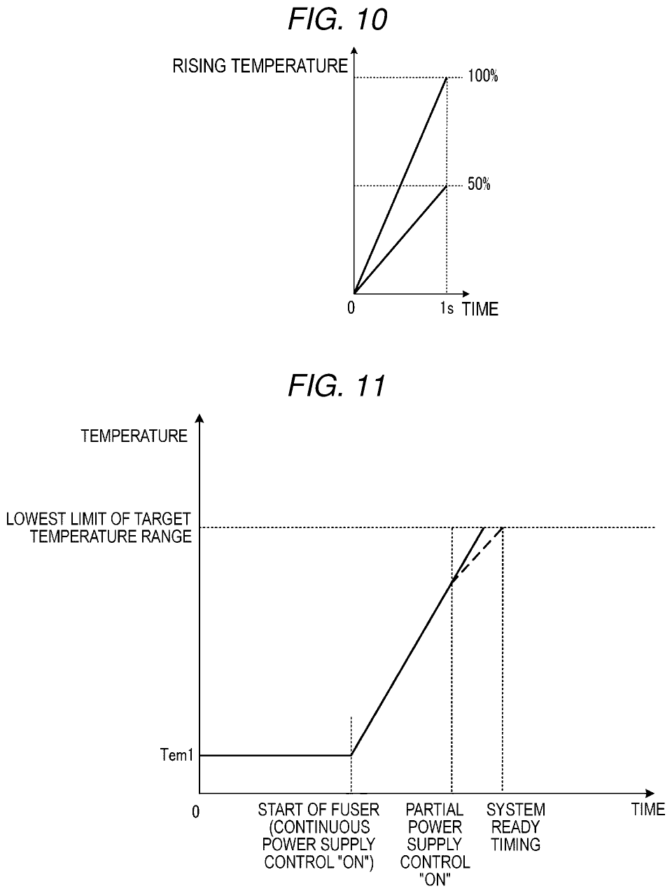

Next, a case in which partial power supply control is applied to the fuser 30 will be supplementary described below. As illustrated in FIG. 10, a comparison between 100% partial power supply control (in a state in which a partial supply rate is 0%) and 50% partial power supply control (a state in which a partial supply rate is 50%) reveals that a temperature rise rate when 100% partial power supply control is performed is higher than that when 50% partial power supply control is performed.

The management information stored in the information management unit 7 includes partial power supply management information indicating a temperature rise rate corresponding to a power supply ratio when partial power supply control is performed. Based on the partial power supply management information, the processor 41 determines how much temperature rise rate is expected in how long period by how much power supply rate is to be set.

For example, after the system is started in ACT4 or ACT9, the processor 41 monitors the progress of starting the system and outputs a control signal for selectively performing continuous power supply control and partial power supply control according to the progress of starting the system activation. The power supply controller 32 selectively performs continuous power supply control and partial power supply control according to the control signal from the processor 41.

FIG. 11 is a diagram for explaining an example of a case in which continuous power supply control and partial power supply control are selectively performed. For example, first, the processor 41 selects continuous power supply control in ACT 6 or ACT 7. The power supply controller 32 performs continuous power supply control according to a control signal from the processor 41. When the processor 41 determines that the progress of starting the system is delayed by a certain time, continuous power supply control is switched to partial power supply control. The power supply controller 32 performs partial power supply control in place of continuous power supply control, according to the control signal from the processor 41. That is, the processor 41 and the power supply controller 32 delay a completion time for preparation of the fuser 30, so that a timing at which the preparation of the system is completed and a timing at which the preparation of the fuser 30 is completed may correspond to each other. Furthermore, the processor 41 determines a timing of switching from continuous power supply control to partial power supply control, based on the predetermined time indicating the delay of the progress of starting the system, and switches continuous power supply control to partial power supply control at the determined timing.

Thereafter, when the processor 41 determines that the progress of starting the system is advanced only by a certain time, partial power supply control is switched to continuous power supply control (it is returned to continuous power supply control from partial power supply control). The power supply controller 32 performs continuous power supply control in place of partial power supply control, based on the control signal from the processor 41. That is, the processor 41 and the power supply controller 32 advance time when the preparation of the fuser 30 is to be completed, so that the timing when the preparation of the system is completed and the timing when the preparation of the fuser 30 is completed may correspond to each other. Alternatively, the processor 41 determines a timing to switch from partial power supply control to continuous power supply control, based on the time indicating the advancing of the progress of starting the system, and switches from partial power supply control to continuous power supply control at the determined timing.

In addition, although a case in which continuous power supply control and partial power supply control are selectively performed is described above, first partial power supply control (for example, a state in which a partial supply rate is 20%) and second partial power supply control (for example, a state in which a partial supply rate is 40%) may be selectively performed. That is, continuous power supply control described above may be replaced with first partial power supply control, and partial power supply control described above may be replaced with second partial power supply control.

Alternatively, continuous power supply control may be performed to change a supply voltage. That is, continuous power supply control of a first supply voltage and continuous power supply control of a second supply voltage which is lower than the first supply voltage may be selectively performed. Similarly, partial power supply control may be performed to change a supply voltage. That is, partial power supply control (for example, a state in which a partial supply rate is 20%) of a first supply voltage and partial power supply control (for example, a state in which a partial supply rate is 20%) of a second supply voltage lower than the first supply voltage may be selectively performed.

Furthermore, start control may be performed on an assumption that a system preparation time varies according to a stopped state of the image forming apparatus M. For example, it is assumed that the image forming apparatus M may be in an operation stop state in which a minimum amount of standby power (first standby power) is supplied, a standby state (power saving mode) in which second standby power which is higher than the first standby power is supplied, or a normal operating state in which operating power which is higher than the second standby power is supplied. In the normal operation state, measured surface temperatures of the heat roller 3101 and the belt heat roller 3115 of the fuser 30 are maintained to be within a target temperature range. In the standby state, the measured surface temperatures of the heat roller 3101 and the belt heat roller 3115 of the fuser 30 are maintained to be within a standby temperature range which is lower than the target temperature range. The processor 41 switches the normal operation state to the standby state, when in the normal operation state, there is no input to the control panel unit 5 for a certain time or the image output unit 3 does not operate for a certain time.

When receiving a start command, the processor 41 determines whether the system is to be started in the operation stop state or the standby state. The management information stored in the information management unit 7 stores a system preparation time T11 (a first system preparation time) required to complete preparation of the system from starting the system which is in the operation stop state, and a system preparation time T12 (a second system preparation time) required to complete the preparation of the system from starting the system which is in the standby state. The system preparation time T12 is shorter than the system preparation time T11.

The processor 41 selects the system preparation time T11 when it is determined that the system is started in the operation stop state, and selects the system preparation time T12 when it is determined that the system is started in the standby state. For example, the processor 41 selects continuous power supply control in response to the selection of the system preparation time T11, and selects partial power supply control in response to the selection of the system preparation time T12. Alternatively, the processor 41 selects first partial power supply control (for example, a state in which a partial supply rate is 20%) in response to the selection of the system preparation time T11, and selects second partial power supply control (for example, a state in which a partial supply rate is 40%) in response to the selection of the system preparation time T12.

As described above, according to start control of the present embodiment, the system and the fuser 30 may be started at an appropriate timing, and a start control method may be selected on the basis of a state of the image forming apparatus M, so that a first timing at which the preparation of the system is completed and a second timing at which the preparation of the fuser 30 is completed may be equalized. That is, the first timing and the second timing may be equalized. Furthermore, even when the first timing is delayed or advanced, that is, the first timing is changed, during performing of start control, the first timing and the second timing may be equalized, based on the change. Thereby, a power saving effect can be expected to be obtained without decreasing user convenience.

In the present embodiment, it is described that, for example, the HR lamp 3102 is configured using a halogen lamp. That is, although start control is described above, for example, with respect to a fuser using a halogen lamp as a heat source, start control described in the present embodiment is not limited to such a fuser using an HR lamp and is applicable to various types of fusers. For example, start control described in the present embodiment is also applicable to a fuser that fuses a toner image on a sheet by heating the toner image via a film type member. Such a fuser using a film-like member tends to have a shorter preparation time from starting the system than that of a fuser using a halogen lamp, and thus, start control according to the present embodiment is performed based on a fusing preparation time of a fuser using a film type member.

While certain embodiments have been described, these embodiments have been presented by way of example only, and are not intended to limit the scope of invention. Indeed, the novel apparatus and methods described herein may be embodied in a variety of other forms; furthermore, various omissions, substitutions and changes in the form of the apparatus and methods described herein may be made without departing from the spirit of the inventions. The accompanying claims and their equivalents are intended to cover such forms or modifications as would fall within the scope and spirit of the inventions.

What is claimed is:

1. An image forming apparatus, comprising:
an image output unit configured to form a toner image on a sheet, including:
a fuser configured to heat the sheet to fix the toner image on the sheet; and
a system processor:
configured to determine whether
a system preparation time is longer or shorter than a fuser preparation time,
the system preparation time being a time period required to complete a system preparation to control the image output unit of the system processor itself,
the fuser preparation time being a time period required to complete a fuser preparation of the fuser,
configured to start the system preparation and the fuser preparation
with a delay between the system preparation and the fuser preparation to equalize
a first timing the first timing at which the system preparation is completed, and
a second timing at which the fuser preparation is completed, and
configured to control image output unit to start to form the toner image after the system preparation and the fuser preparation are completed.

2. The apparatus of claim 1, wherein
the fuser preparation time varies according to an environmental temperature.

3. The apparatus of claim 2, wherein
the system processor determines the delay,
the system processor controls the image output unit to start the fuser preparation after the delay after starting the system preparation
if the system processor determines that the system preparation time is longer than the fuser preparation time, and
the system processor starts the system preparation after the delay after staring the fuser preparation
if the system processor determines that the system preparation time is shorter than the fuser preparation time.

4. The apparatus of claim 1, further comprising
a memory configured to store a management information including:
a system preparation time, and
a fuser preparation time.

5. The apparatus of claim 4, wherein
the system processor determines whether
the system preparation time is longer or shorter than the fuser preparation time according to the management information.

6. The apparatus of claim 5, wherein
the image output unit includes:
a fuser controller configured to perform a first heating control and a second heating control for the fuser,
the first heating control is a continuous power supply control, and
the second heating control is a partial power supply control.

7. The apparatus of claim 6, wherein
the fuser preparation time includes:
a time required for fuser preparation when the fuser controller performs the first heating control, and
a time required for fuser preparation when the fuser controller performs the second heating control.

8. The apparatus of claim 7, wherein
the fuser preparation time further includes:
a time required for fuser preparation when the fuser controller selectively performs the first heating control and the second heating control.

9. The apparatus of claim 1, further comprising:
a temperature sensor configured to sense an environmental temperature of an environment in which the apparatus is installed,
wherein the system processor:
determines whether the system preparation time is longer or shorter than the fuser preparation time according to the environmental temperature.

10. The apparatus of claim 9, further comprising:
a memory configured to store a management information including
a system preparation time, and
a fuser preparation time,
wherein the memory stores the fuser preparation time in correspondence with the environmental temperature.

11. The apparatus of claim 9, further comprising:
an image reader configured to generate image information.

12. The apparatus of claim 11, wherein
the system processor:
receives the image information from the image reader, and
controls the image output unit to form the toner image according to the image information.

13. The apparatus of claim 12, wherein
the system processor further includes an external interface controller configured to receive an image data.

14. The apparatus of claim 13, wherein
the system processor controls the image output unit to form the toner image according to the image data.

15. An apparatus of claim 9, wherein
the fuser includes a fuser temperature sensor configured to sense a fuser temperature of the fuser, and
the system processor determines whether the system preparation time is longer or shorter than the fuser preparation time according to the fuser temperature.

16. An apparatus of claim 15, wherein
the fuser temperatures sensor includes a first temperature sensor and a second temperature sensor, and
the system processor determines whether the system preparation time is longer or shorter than the fuser preparation time according to an average of temperatures sensed by the first temperature sensor and the second temperature sensor.
